(19) United States
(12) Patent Application Publication
(10) Pub. No.: US 2010/0139680 A1
(43) Pub. Date: Jun. 10, 2010

(54) FISH PEDICURES, MASSAGES AND TREATMENTS

(76) Inventors: John Ho, Alexandria, VA (US); Yvonne Le, Alexandria, VA (US)

Correspondence Address: BACON & THOMAS, PLLC, 625 SLATERS LANE, FOURTH FLOOR, ALEXANDRIA, VA, 22314-1176, US

(21) Appl. No.: 12/331,970

(22) Filed: Dec. 10, 2008

(51) Int. Cl. A61H 33/00

(52) U.S. Cl. 132/200

(57) ABSTRACT

A method of treatment of the skin of a human individual by fish which eat the top layer of skin includes providing a separate supply of fish for the individual, and suspending the skin to be treated in water in a fish container which may be adapted to receive a specific body part, such as a single foot or two feet, or a single hand or two hands. Each fish must be large enough to eat the top layer of skin of the individual, but should not have matured to the point of being capable of reproduction.

### BACKGROUND OF THE INVENTION

1. Technical Field

This invention relates to the use of fish in pedicures, manicures, massages and other treatments of human skin, and in particular human feet. These treatments include full body treatments.

2. Description of Prior Art

In the prior art, the skin of humans was treated by fish in large pools which allowed for the full immersion of numerous people. For example, the prior art includes an immersion pool which allows for the side-by-side placement of chairs, such as reclining chairs that are typically used on the sides of swimming pools. The depth of the water may be one meter or more, and allow for the full immersion of the lawn chair. Persons may be seated in a reclining position in the lawn chairs, and carry on conversations with other persons in the pool during these fish treatments. The body of each person in the pool for treatment may be submerged from the neck down. The pool is stocked with a specific fish, or related breeds of fish, which eat the top layer of skin of the persons in the pool. This is a gradual process which may provide a sensation of tickling on the skin, and is not painful. The fish may remove callouses and other amounts of skin from the top layer of the skin exposed to the water. Portions of the bodies of the humans in the pool may be protected by swimming suits or other garments.

### SUMMARY OF THE INVENTION

The present invention is directed to a method of treatment of the skin of a human individual by fish which eat the top layer of skin, wherein a separate supply of fish is provided for each individual, and the skin to be treated is suspended in the water. In a preferred embodiment of the invention, a separate supply of fish is provided for a specific body part, such as a single foot or two feet, or a single hand or two hands. A separate fish container is provided for each individual. For example, a fish container may comprise a small tub which is of sufficient size to allow for the placement of two feet into the tub, and the immersion of the feet in a depth of water up to about the ankle. During the treatment, the feet must be suspended in the water, and should not be resting on the bottom of the tub, so the fish may treat the bottom of each foot. Each fish must be an intermediate fish which is large enough to eat the top layer of skin of the individual, but has not yet matured to the point of being capable of reproduction. The effect of the fish treatment may be similar to a pedicure or massage. The fish treatment may be combined with a conventional pedicure and massage that are performed by humans. The present invention includes fish treatments of the full body with a separate supply of fish for each individual. In the case of a full body treatment, breathing apparatus may be used. The breathing apparatus may be similar to a snorkel or other underwater breathing devices.

### DESCRIPTION OF THE DRAWINGS

FIG. 1 is a schematic diagram of a fish container according to the present invention.

### DETAILED DESCRIPTION OF THE INVENTION

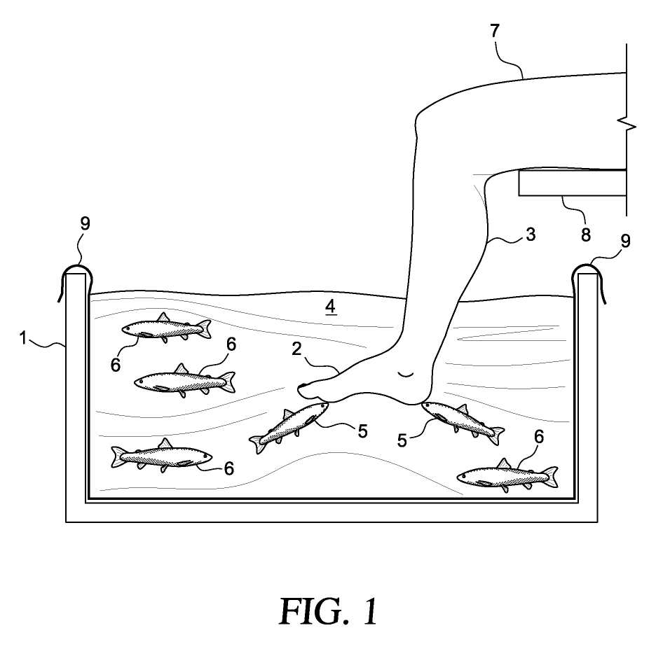

Referring now to FIG. 1, the fish container is a small tub 1 adapted to receive a human foot 2, and water 4 containing multiple fish 5 and 6. Multiple fish 5 are shown eating the top layer of skin from foot 2, and multiple fish 6 are shown swimming in the water 4 in tub 1. The top surface of water 4 in container 1 allows the entire foot 2 to be submerged, and allows multiple fish 5 access to the top, bottom and all surfaces of foot 2. The calf 3 is partially submerged. Thigh 7 of the individual is supported by chair 8 or other horizontal surface, so as to position foot 2 in tub 1 such that water 4 completely surrounds the foot, including the bottom of the foot. Thus, the bottom of foot 2 is held sufficiently above the bottom of container 1 so that multiple fish 5 may eat the top layer of skin from the bottom layer of the foot. In a preferred embodiment, a flexible member such as plastic bag 9 is positioned between the water 4 and the interior of fish tub 1, to allow for easy cleanup by disposal of plastic bag 9 after the treatment of the foot or feet of an individual. In a preferred embodiment of the invention, tub 1 and liner 9 are clear, transparent materials, which allow the visual observation of the contents of the container.

The present methods of fish pedicures, massages and treatments may be provided in a number of locations, including hotels, medical facilities and beauty salons. The follow description may mention the example of a salon, but this should not be considered a limitation on the location where the treatment is provided.

An individual may arrive at a salon and order a fish treatment, massage or pedicure. In the following example, a fish pedicure will be discussed, but the invention is not limited to pedicures. The examples discussed below may refer to the feet of the individual, but the invention is applicable to a single foot as well. The individual would remove any socks and shoes, and the individual's feet would be washed. The provider of the fish pedicure would inspect the feet for any fresh cuts or other abrasions. If the feet contain any fresh cuts or other abrasions, then the provider would recommend a deferral of treatment until any fresh cuts and abrasions are healed. The skin of the feet should have no cuts or abrasions, as a condition of proceeding with the fish pedicure. The feet of the individual may be placed in disposable slippers to keep them clean, until the treatment begins.

The individual would be seated in a chair, or other suitable supporting structure. A clear fish container would be prepared by inserting a new, clean plastic liner into the fish container, and pouring a quantity of water containing fish into the container. The feet of the individual would be placed into the water in the container. The height of the chair, relative to the position of the fish container, would suspend the feet in the water so that the fish in the water may have access to all surfaces of the feet.

The amount of time that the feet of the individual are in the water containing fish in the fish container may be adjusted depending on a number of factors. These factors include the size of the feet, the number of fish in the water, and the eating capacity of the fish. The time of the treatment may vary from minutes to hours in a typical practice of the processes of the present invention. The feet of the individual may be periodically lifted out of the water in the fish container for inspection. If the inspection determines that the fish have eaten an adequate amount of skin, then the submersion may be terminated. On the other hand, if the inspection determines that the fish need to eat additional skin, then the submersion may be continued.

The temperature of the water in the fish container should be comfortable for the human individual, and suitable for the fish. Thus, the exact temperature may have to be adjusted depending on the preferences of the individual, and the nature of the fish.

The fish must be capable of eating the top layer of skin of an individual within an acceptable period of time. A suitable species include Garra Rufa of both the original Turkish type, and the currently available hybrid types. Suitable fish may be imported from breeders and brokers in other countries including China. Fish from outside the country are not native species, and must be contained. The non-native fish cannot be allowed to get into domestic waters.

The age of suitable fish depends on a number of factors. Generally speaking, the fish should be suitable in about 4 to 6 weeks after the fish hatch, and achieve a size of about 0.75 inch.

The fish may be killed by chlorinated water. Therefore, other precautions must be taken to insure the health and safety of individuals who receive the fish pedicures. In one embodiment of the invention, the supply of fish may be maintained in a storage tank with the water re-circulated through an ultraviolet apparatus to kill any bacteria in the water. The fish would not be allowed to go through the UV apparatus, by a filter or other means.

In another embodiment of the invention, the fish supply may be in multiple storage tanks. For example, one tank may contain fish that are used for pedicures on Mondays, Wednesdays and Fridays, and a second tank may contain fish that are used for pedicures on Tuesdays, Thursdays and Saturdays (and the fish may be given Sunday off). In another embodiment of the invention, it may be desirable to have a third tank as an alternative. This would allow fish to be removed from the first tank to the third tank, the first tank cleaned, and then the fish return from the third tank to the first tank. The third tank can then be cleaned, and the fish from the second tank could be placed into the third tank, the second tank cleaned, and the fish returned to the second tank. The invention may comprise a return tank that holds water used in fish treatments until the end of the day, when it may be returned to the first tank or second tank, depending on the day of the week. Other regiments are within the scope of the invention. For example, if UV treatment of the water for a week between uses of the water in pedicures is desirable, then a storage tank for each day of the week may be used.

The environment of the fish in each storage tank should be monitored so that the fish are in good condition for performing fish pedicures and treatments. The fish may be fed once in the morning, and once in the evening. The lighting of the fish storage tanks may be maintained during the day, and turned off at night. This may allow the fish to go into hibernation while the lights are turned off and the fish storage tanks are dark.

A large tank or indoor fish pond may be used to provide an adequate supply of fish. It has been found that the fish grow based in part on the size of the pond. Thus, the maximum size of the fish may be controlled in part by the size of the pond. It has also been found that the fish will not breed unless the pond is sufficiently large in size. In one embodiment of the invention, the indoor fish pond should have a size of about 250 gallons of water or more. Fish ponds of larger size are advantageous.

The size of the fish should be monitored. The fish may be used in fish pedicures and treatments starting when the fish are about 0.75 inch in length. The size of the fish may be limited to a maximum of about 3.5 inches in length. The fish may not breed unless the size reaches 5 or 6 inches or more.

The fish may be imported from foreign sources. There are advantages to importing fish having a size of about 0.75 inch. After the fish are flown to this country. The fish are of sufficient size to be immediately used in fish pedicures and treatments. In addition, fish of this size are stronger than smaller fish, and fewer fish are lost due to the stress of transit from the foreign source to this country.

The fish may be disposed of after they reach a size of about 5 or 6 inches or more. One method of disposal is to ship the fish back to the foreign country from which the fish originated. Another method is to kill the fish. If the fish are not native species, then they should not be allowed to enter the domestic water. At the present time, the only suitable breeds of fish known are foreign to this country. There is the possibility that a domestic breed of fish may subsequently be discovered as suitable for the present fish pedicures and massages. If a domestic species of fish is found suitable, then the disposal of the domestic fish may be to domestic waters. There may be advantages to using some of the largest fish to reproduce, so that an adequate supply of younger fish is maintained.

We claim:

1. A method of a method of treatment of the skin of a human individual which comprises the following steps:
(1) placing fish, water and a body part of said human individual into a fish container;
(2) suspending said body part in said water,
(3) allowing said fish to eat a top layer of skin from said body part for a first period of time, and
(4) removing said body part from said water.

2. The method of claim 1 wherein a flexible member is placed into said fish container before said fish, said water and said body part are placed into said fish container, and wherein said flexible member and said fish container are transparent.

3. The method of claim 1 wherein said body part is selected from a foot and a hand.

4. The method of claim 1 wherein is said body part is a first foot of said individual, and said suspending further comprises suspending a second foot of said individual in said water.

5. The method of claim 1 wherein said body part is inspected for a cut and for an abrasion before said body part is placed in said fish container.

6. The method of claim 1 wherein said first period of time is determined based on a size of said body part, a number of said fish in said water, and an eating capacity of said fish.

7. The method of claim 1 wherein an initial temperature of said water is determined to be comfortable for said human individual, and suitable for said fish.

8. The method of claim 1 wherein a species of said fish is selected from the group consisting of a Garra Rufa of the original Turkish type, a Garra Rufa hybrid type, and combinations thereof.

9. The method of claim 1 wherein each of said fish is from 0.75 inch to about 3.5 inches in length.

10. The method of claim 1 wherein said fish does not come into contact with a second human individual in said fish container, and said fish does not come into contact with said second human individual for at least one day before being placed in said fish container with said body part.

11. The method of claim 1 wherein said fish is stored in a fish tank for a first storage period of time before said fish is placed into said fish container, and wherein is said fish tank comprises storage water, and said storage water is re-circulated through an ultraviolet apparatus to kill a bacteria in said storage water.

12. The method of claim 11 wherein said first storage period of time is at least a day, and said fish is not in contact with a second human individual from the beginning of said first storage period of time until after said removing.
